(19) United States
(12) Patent Application Publication
(10) Pub. No.: US 2024/0383225 A1
(43) Pub. Date: Nov. 21, 2024

(54) COMPOSITE STRUCTURES WITH EMBEDDED SENSORS

(71) Applicant: Wabash National, L.P., Lafayette, IN (US)

(72) Inventor: Joshua Hagan, Orlando, FL (US)

(73) Assignee: Wabash National, L.P., Lafayette, IN (US)

(21) Appl. No.: 18/666,373

(22) Filed: May 16, 2024

Related U.S. Application Data
(60) Provisional application No. 63/467,759, filed on May 19, 2023.

(51) Int. Cl. B32B 5/18; B32B 27/06; B32B 27/20; B32B 33/00; B32B 38/00; B32B 43/00

(52) U.S. Cl. CPC B32B 5/18; B32B 27/065; B32B 27/20; B32B 33/00; B32B 43/003; B32B 2038/0076; B32B 2262/101; B32B 2262/124; B32B 2266/0278; B32B 2305/08; B32B 2305/34; B32B 2375/00; B32B 2605/08

(57) ABSTRACT

A composite structure with at least one wireless sensor embedded in the core material so that the wireless sensor is capable of collecting data related to the corresponding composite structure without creation of a structural void or defect. For example, the composite structure may include a core layer with a foam core and a core fiber-reinforced polymer layer surrounding the foam core. The at least one wireless sensor may be positioned within the foam core and coupled to an inner surface of the core fiber-reinforced polymer layer.

### CROSS-REFERENCE TO RELATED APPLICATION

The present application claims priority to U.S. Provisional Patent Application Ser. No. 63/467,759, filed May 19, 2023, the entire disclosure of which is incorporated herein by reference.

### FIELD OF THE DISCLOSURE

The present disclosure relates generally to composite structures and methods of making the same. More particularly, the present disclosure relates to composite structures for use in vehicles including boats, trains, cargo vehicles including vans and trucks, and other applications having embedded sensors and methods of making the same.

### BACKGROUND OF THE DISCLOSURE

Cargo vehicles are used in the transportation industry for transporting many different types of cargo. Cargo vehicles may be constructed using composite materials, which may lead to an absence of or reduction in metallic and wood materials and associated advantages, including simplified construction, thermal efficiency, reduced water intrusion and corrosion, and improved fuel efficiency through weight reduction, for example. However, such cargo materials must be sufficiently strong and durable to withstand the demands of normal use, both exteriorly (e.g., weather, road or rail conditions, other vehicles) and interiorly (e.g., cargo, forklifts).

Sensors are used to monitor a variety of data points including load, strain, pressure, temperature, light, and other factors. Embedding sensors in composite structures using the conventional method, within laminate, causes a void defect in the support structure, which can result in structural failure.

### SUMMARY OF THE DISCLOSURE

The present disclosure relates to a composite structure with at least one wireless sensor embedded in the core material so that the wireless sensor is capable of collecting data related to the corresponding composite structure without creation of a structural void or defect.

In a first aspect of the disclosure, a composite structure of a cargo body is disclosed. The composite structure includes a core layer having a foam core and a core fiber-reinforced polymer layer; an outer fiber-reinforced polymer layer adjacent the core layer; an inner fiber-reinforced polymer layer adjacent the core layer; and at least one wireless sensor positioned within the foam core and coupled in an inner surface of the core fiber-reinforced polymer layer.

In a second aspect of the disclosure, a preform for construction of a composite structure is disclosed. The preform includes a foam core; a permeable intermediate layer surrounding the foam core; a fiber-reinforced polymer layer surrounding the permeable intermediate layer; and a wireless sensor positioned within the foam core and attached to an inner surface of the permeable intermediate layer so that the at least one wireless sensor contacts the fiber-reinforced polymer layer via pores of the intermediate layer.

In a third aspect of the disclosure, a method of manufacturing a composite structure is disclosed. The method includes providing a fiber-reinforced polymer and a nonwoven fabric; attaching a wireless sensor to the nonwoven fabric; providing foam material to the nonwoven fabric and over the wireless sensor relative to the nonwoven fabric; curing the foam material; and cutting the composite structure to a predetermined size.

In various aspects of the disclosure, the cargo body may include one of a trailer, a van, a train, and a boat.

In various aspects of the disclosure, the foam core may be coupled to the inner surface of the core fiber-reinforced polymer layer via an intermediate layer positioned between the core fiber-reinforced polymer layer and the foam core. The intermediate layer may be a permeable material to facilitate contact between the wireless sensor and the core fiber-reinforced polymer layer.

In various aspects of the disclosure, the composite structure may further include a gel coat positioned on at least one of the outer fiber-reinforced polymer layer and the inner fiber-reinforced polymer layer opposite the core layer.

In various aspects of the disclosure, a control system of the cargo body may be communicatively coupled to the wireless sensor. The control system may be configured to receive and process signals transmitted by the wireless sensor.

In various aspects of the disclosure, the composite structure may be a single, unitary structure.

In various aspects of the disclosure, the fiber-reinforced polymer layer may include a polymer matrix reinforced with a fiberglass fabric.

In various aspects of the disclosure, the permeable intermediate layer may be a nonwoven fabric.

In various aspects of the disclosure, the preform may comprise a plurality of wireless sensors.

In various aspects of the disclosure, the permeable intermediate layer may be mechanically coupled to the fiber-reinforced polymer layer.

In various aspects of the disclosure, the foam core may include a polyurethane foam.

In various aspects of the disclosure, the wireless sensor may be attached to the inner surface of the permeable intermediate layer via adhesive.

In various aspects of the disclosure, the foam material may be a self-curing material.

In various aspects of the disclosure, attaching the wireless sensor to the nonwoven fabric may include applying adhesive to at least one of the wireless sensor and the nonwoven fabric.

In various aspects of the disclosure, the method may include applying an additional layer of fiber-reinforced polymer to the fiber-reinforced polymer. The method may also include applying a gel coat to the additional layer of fiber-reinforced polymer.

In various aspects of the disclosure, a plurality of wireless sensors may be attached to the nonwoven fabric.

Additional features and advantages of the present invention will become apparent to those skilled in the art upon consideration of the following detailed description of the illustrative embodiments exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1 illustrates an exemplary cargo body of the present disclosure;

FIG. 2 illustrates a cross section of a composite structure of the cargo body of FIG. 1; and

FIG. 3 illustrates a cross-section of a preform of the composite structure of FIG. 2 having a wireless sensor.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

For the purposes of promoting an understanding of the principals of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

### 1. Cargo Vehicle

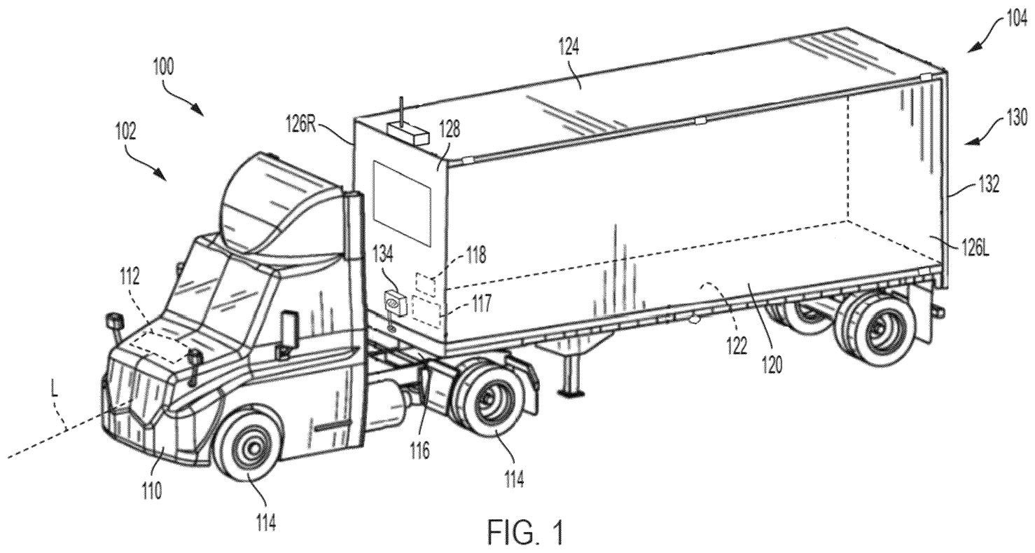

Referring initially to FIG. 1, a cargo vehicle 100 is shown for supporting and transporting cargo. The illustrative vehicle 100 is a tractor-trailer that extends along a longitudinal axis L from a front end 102 to a rear end 104. The vehicle 100 may include a tractor 110 and a cargo body 120, specifically a refrigerated van trailer. The tractor 110 of the vehicle 100 may include an engine 112, a plurality of wheels 114 powered by the engine 112, and a fifth wheel assembly 116.

The cargo body 120 of the vehicle 100 may include a power source 117 (i.e., a battery) charged by the engine 112 of the tractor 110 or another suitable charging device, a control system 118 in communication with the power source 117, a floor 122 for supporting cargo, a roof 124, right and left sidewalls 126R, 126L, a front wall or nose 128, and a rear door assembly 130 having a rear frame 132 and a door (not shown) to access the cargo body 120. The power source 117 and the control system 118 are shown as being incorporated into the front wall 128 of the cargo body 120 in FIG. 1, although this arrangement may vary both in an exemplary vehicle as shown and in other cargo bodies or composite structures. The cargo body 120 may include a king pin assembly (not shown) that couples to the fifth wheel assembly 116 of the tractor 110. The cargo body 120 also may include an electrical connector 134, such as a 7-way plug, that communicates with the tractor 110 when coupled together to charge the power source 117 and/or power electrical components of the cargo body 120.

While the concepts of this disclosure are described in relation to a refrigerated van trailer, it will be understood that they are equally applicable to other cargo bodies, including other trailers (e.g., dry van trailers, flatbed trailers, commercial trailers, small personal trailers), straight or box truck bodies, vans, trains, and boats. The concepts are additionally equally applicable to other composite structures, such as composite walls, floors, ceilings, etc. for outbuildings, sheds, kennels, animal housing, and other structures that may be formed of composite materials as described herein. Accordingly, those skilled in the art will appreciate that the present invention may be implemented in a number of different applications and embodiments and is not specifically limited in its application to the particular embodiments depicted herein.

### 2. Composite Sidewalls and Other Composite Structures

Cargo body 120 may be constructed, at least in part, of composite materials. For example, the floor 122, roof 124, right and left sidewalls 126R, 126L, and/or front wall 128 of the composite cargo body 120 may be constructed of composite materials. As such, the floor 122, roof 124, right and left sidewalls 126R, 126L, and/or front wall 128 of the composite cargo body 120 may be referred to herein as composite structures. Each composite structure may be a single, unitary component, which may be formed from a plurality of layers permanently coupled together. Exemplary composite materials for use in the composite cargo body 120 include fiber-reinforced polymers or plastics (FRPs), for example glass-fiber-reinforced polymers or plastics (GFRPs) and carbon-fiber-reinforced polymers or plastics (CRPs).

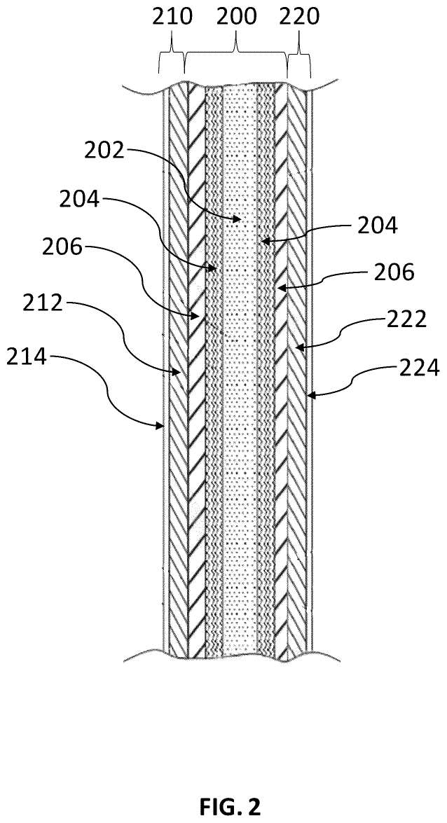

A laminated composite left sidewall 126L is shown in cross-section in FIG. 2. Those skilled in the art will appreciate that the following teachings related to the left sidewall 126L may also be applied to the floor 122, roof 124, right sidewall 126R, and/or front wall 128 of the composite cargo body 120. Similarly, the following teachings may also be applied to composite structures forming other vehicles, portions of vehicles, buildings, or other structures capable of being made of composite materials. In other words, the references made herein to composite cargo body 120 and its components are made for exemplary and illustrative purposes only.

The illustrative sidewall 126L of FIG. 2 includes a core layer 200, an outer skin layer 210 that faces outwardly from the cargo body 120 (FIG. 1) toward the surrounding environment, and an inner skin layer 220 that faces inwardly toward the cargo in cargo body 120 (FIG. 1). Each of these laminated layers 200, 210, 220 is described further below.

Referring still to FIG. 2, the core layer 200 of the composite sidewall 126L may include one or more structural supports or preforms. Each preform may include an inner foam core 202, an intermediate layer 204, and an outer FRP layer 206, each of which is described further below.

The inner foam core 202 of each preform may include a self-expanding, self-curing structural foam material. Suitable foams include polyurethane foams, such as a methylene-diphenyl-methane diisocyanate (MDI) based rigid polyurethane foam, for example.

The outer FRP layer 206 (which may be referred to herein as the “first” FRP layer 206) of each preform may include a polymer matrix reinforced with fibers configured to enhance the structural properties of the surrounding polymer matrix. Suitable reinforcing fibers include glass fibers, carbon fibers, aramid fibers (e.g., Kevlar® fibers available from DuPont Protection Technologies of Richmond, Virginia), linear polyethylene or polypropylene fibers (e.g., Spectra® fibers available from Honeywell International Inc. of Morris Plains, New Jersey), or polyester fibers. The reinforcing fibers may be present in fabric form, which may be mat, woven, or knit, for example. Exemplary fabrics include chopped fiber fabrics, such as chopped strand mats (CSM), and continuous fiber fabrics, such as 0°/90° fiberglass fabrics, +45°/−45° fiberglass fabrics, +60°/−60° fiberglass fabrics, 0° warp unidirectional fiberglass fabrics, and other stitched fiber fabrics, for example. Exemplary fabrics are commercially available from Vectorply Corporation of Phenix City, Alabama and include the E-LM 1810 fiberglass fabric with 0° unidirectional fibers, the E-LTM 3610 fiberglass fabric with 0°/90° fibers, and the E-LTM 2408 fiberglass fabric with 0°/90° fibers, for example. Such fabrics may have an area density of about 800 g/m² to about 1,500 g/m² or more. In other embodiments, exemplary fabrics may have an area density of about 400 g/m² to about 1,500 g/m². In yet other embodiments, exemplary fabrics may have an area density of about 220 g/m² to about 240 g/m².

The intermediate layer 204 of each preform may serve as a transition layer for coupling the inner foam core 202 to the outer FRP layer 206. The intermediate layer 204 may be sufficiently permeable to at least partially receive foam from the adjacent foam core 202 and the polymer matrix from the adjacent FRP layer 206. The intermediate layer 204 may also be mechanically coupled (e.g., stitched) to the adjacent FRP layer 206 to simplify manufacturing, to ensure proper placement, and to prevent shifting and/or bunching. The intermediate layer 204 may be a nonwoven fabric with continuous or chopped fibers.

The individual preforms of the core layer 200 may be designed to accommodate the needs of the particular application. For example, in areas of the final structure requiring more strength and/or insulation, a low-density foam core 202 may be replaced with a high-density foam core 202 or a hard, plastic block. The individual preforms of the core layer 200 may also be sized, shaped, and arranged in a manner that accommodates the needs of the particular application. For example, in areas of the final structure requiring less strength, the preforms may be relatively large in size, with the foam cores 202 spanning relatively large distances before reaching the surrounding layers 204, 206. By contrast, in areas of the final structure requiring more strength, the preforms may be relatively small in size, with the foam cores 202 spanning relatively small distances before reaching the surrounding layers 204, 206. Stated differently, the preforms may be shaped as relatively wide panels in areas of the final structure requiring less strength and as relatively narrow support beams in areas of the final structure requiring more strength.

Referring still to FIG. 2, the outer skin layer 210 of the composite sidewall 126L may include a FRP layer 212 and an outer gel coat 214. The FRP layer 212 (which may be referred to herein as the “second” FRP layer 212) may be similar to the above-described first FRP layer 206, including a polymer matrix reinforced with suitable reinforcing fibers. According to an exemplary embodiment of the present disclosure, a plurality of different reinforcing fiber layers may be stacked together and used in combination to form the FRP layer 212. For example, a chopped fiber fabric (e.g., CSM) may be positioned adjacent to a continuous fiber fabric. In this stacked arrangement, the chopped fibers may help support and maintain the adjacent continuous fibers in place, especially around corners or other transitions. Also, the chopped fibers may serve as a web to resist column-type loads in compression, while the adjacent continuous fibers may resist flange-type loads in compression. Adjacent reinforcing fiber layers may be stitched or otherwise coupled together to simplify manufacturing, to ensure proper placement, and to prevent shifting and/or bunching. The outer gel coat 214 may be a polymer-rich or polymer-only layer that provides a smooth outer finish in a desired color.

Referring still to FIG. 2, the inner skin layer 220 of the composite sidewall 126L may include a FRP layer 222 and an optional inner gel coat 224. The FRP layer 222 (which may be referred to herein as the “third” FRP layer 222) may be similar to the above-described first and second FRP layers 206, 212, including a polymer matrix reinforced with suitable reinforcing fibers. The inner gel coat 224 may be a polymer-rich or polymer-only layer similar to the above-described outer gel coat 214 that provides a smooth inner finish in a desired color.

### 3. Manufacturing Method

The preforms of the composite structures of the present disclosure may be formed via a molding process. For example, the FRP layer 206 and the intermediate layer 204 may be secured to each other mechanically, such as via conventional stitching, needle punching, stabling, buttons, adhesives, or other coupling mechanisms as discussed further below or further herein. The combined FRP layer 206 and intermediate layer 204 may then be positioned within a mold and filled with self-expanding, self-curing structural foam material to create inner foam core 202 as discussed above.

The composite structures of the present disclosure may be formed by a layered molding process. An exemplary molding process involves (1) applying a gel-coat resin onto a mold surface to form the outer gel coat 214, (2) layering the reinforcing fibers of the outer FRP layer 212, the preforms of the core layer 200, the reinforcing fibers of the inner FRP layer 222, and any other desired layers onto the outer gel coat 214, (3) wetting out the layers 212, 200, 222, and any other applied layers with at least one laminating resin to impregnate and/or coat the fibers, (4) optionally applying another gel-coat resin onto the layers 212, 200, 222 to form the inner gel coat 224, and (5) curing the materials upon the mold surface (either sequentially and/or simultaneously) to form a single, integral, laminated composite sidewall 126L.

The laminating resin of step (3) may be a typical thermosetting resin, such as a vinyl ester, epoxy resin, or unsaturated polyester resin, although thermoplastic resins are also contemplated. The gel-coat resin of steps (1) and (4) may be a typical polyester gel-coat resin or a co-cure resin containing one or more elastomer components, such as urethane, co-cured with one or more laminating resin components, such as a vinyl ester, epoxy resin, or unsaturated polyester components. Exemplary co-cure resins are disclosed in U.S. Pat. No. 9,371,468 and U.S. Publication No. 2016/0263873, the disclosures of which are hereby incorporated by reference in their entireties.

Additional information regarding the construction of composite structures is disclosed in the following patents, each of which is incorporated by reference in its entirety herein: U.S. Pat. Nos. 5,429,066, 5,664,518, 5,800,749, 5,830,308, 5,897,818, 5,908,591, 6,004,492, 6,013,213, 6,206,669, 6,496,190, 6,497,190, 6,543,469, 6,723,273, 6,755,998, 6,869,561, 6,911,252, 8,474,871, 10,239,265.

While a molding method for manufacture of preforms and other composite structures is disclosed above, preforms and other composite structures may be constructed using other methods as known in the art. For example, such structures may be manufactured using a continuous manufacturing method as disclosed in U.S. application Ser. No. 18/509,444 filed on Mar. 12, 2024, and entitled “CONTINUOUS MANUFACTURING OF A COMPOSITE STRUCTURE”, the entirety of which is hereby incorporated by reference herein.

### 4. Embedded Sensor

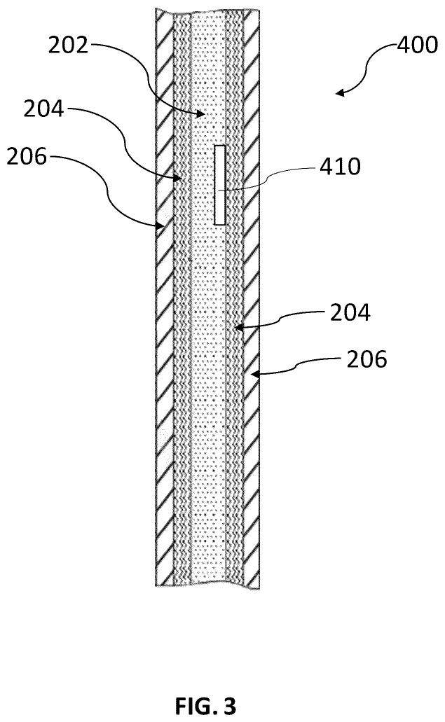

Referring to FIG. 3, a preform 400 of a composite structure may include a wireless sensor 410 embedded within the foam core 202 of the preform 400. Each preform 400 of the corresponding composite structure may include a wireless sensor 410. In some embodiments, fewer preforms 400 of the corresponding composite structure may include a wireless sensor 410. For example, about 90%, about 80%, about 70%, about 60%, about 50%, about 40%, about 30%, about 20%, or about 10% of preforms may include a wireless sensor 410. In some embodiments, one preform of the corresponding composite structure may include a wireless sensor 410. In some embodiments, each preform having a wireless sensor may include only one wireless sensor. In other embodiments, each preform having a wireless sensor may include a plurality of wireless sensors. In yet other embodiments, preforms having a wireless sensor may include a varying number of wireless sensors. While the exemplary embodiment herein is discussed as a preform, it is within the scope of the disclosure that wireless sensor 410 may be included on any composite structure as described above.

The wireless sensor 410 may be attached to the intermediate layer 204 via adhesive, such as a sticker, glue, resin or other adhesive mechanism, or attached to the intermediate layer 204 via other attachment methods, including mechanical attachment mechanisms, for example. The wireless sensor 410 may be in contact with the FRP layer 206 via the polymer matrix and/or resin permeating the intermediate layer 204 as described above. In other words, the wireless sensor 410 may be attached to the intermediate layer 204 opposite of the FRP layer 206. The wireless sensor 410 may be attached to the intermediate layer 204 before the preform is filled with foam during the manufacturing process. In other words, the wireless sensor 410 may be attached to the intermediate layer 204 and the foam material is then introduced to create the foam core 202 as described above so that the wireless sensor 410 is generally surrounded by the foam core 202 except, in some cases, where the wireless sensor 410 is directly attached to the intermediate layer 204. The foam core 202 may be introduced using any of a composite mold method, continuous manufacturing method, or other effective manufacturing method as understood in the art.

Placement of the wireless sensor 410 avoids structural defect by creating a void within the foam core, which provides preform 400 with shape, rather than within the structural fabric made up of intermediate layer 204 and FRP layer 206 or between layers of the composite structure described above. Because the wireless sensor 410 remains in direct contact with the FRP layer 206 via the polymer matrix and/or resin permeating the intermediate layer 204, performance of the wireless sensor 410 is remains unhindered or at least substantially unhindered. For example, the wetting out step of the manufacturing process as discussed in Section 3 ensures that the resin reaches the wireless sensor 410 so that the wireless sensor 410 is in direct contact with the resin and thereby in contact with an outer layer of preform 400, facilitating function of the wireless sensor 410 in collecting data from the outer surface of the corresponding composite structure. In other words, the wireless sensor 410 is configured to receive and/or transmit data through the layers of preform 400. The wireless sensor 410 may be able to collect data throughout the phases of the life and use of the preform, from manufacturing to commercial deployment. While the wireless sensor 410 is illustrated as being attached to the right side of the preform 400, the wireless sensor 410 may be placed against any inner surface of the intermediate layer 204 of FRP layer 206. For example, the wireless sensor 410 may be positioned along any side or edge of the preform 400.

The wireless sensor 410 may communicate electrical signals to the control system 118 (FIG. 1) (e.g., to a controller of control system 118) to provide data information to a user. For example, throughout the manufacturing process, the wireless sensor 410 may communicate signals that facilitate quality control of the preform and/or composite structure, including collecting and communicating data related to the cure phase of the resin and/or temperature of the cure and collecting and communicating data related to the processing temperature in a continuous manufacturing event. In some embodiments, the wireless sensor 410 may collect data and communicate signals facilitating the tracking of raw materials, lot information, and/or other manufacturing or customer data, which may allow for tracking of materials or product in the event of a warranty issue or recall. In other embodiments, the wireless sensor 410 may collect and communicate data related to the load of a vehicle and/or trailer and/or other composite structure, collect and communicate data related to overload or impact of a vehicle and/or trailer and/or other composite structure, and/or collect and communicate data related to the humidity and/or water absorption within foam panels to facilitate detection and impact of water intrusion in monitoring long term health of the preform or other composite structure.

In other embodiments, wireless sensor 410 may collect and communicate data indicative of the temperature throughout a vehicle and/or trailer, optionally including data indicative of temperature in different compartments of said vehicle and/or trailer. Wireless sensor 410 may collect and communicate light intrusion within a trailer, train car, or another composite structure to determine if and when said trailer, train car, or structure was opened. Wireless sensor 410 may collect and communicate data indicative of strain to facilitate determination of whether products are used outside of standard operating conditions. Other uses of the wireless sensor 410 exist as known by one skilled in the art. The control system 118 may be programmed to process signals provided by the wireless sensor 410 and communicate relevant information to the driver, the owner, or other parties.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

What is claimed is:

1. A composite structure of a cargo body, the composite structure comprising:
a core layer including a foam core and a core fiber-reinforced polymer layer;
an outer fiber-reinforced polymer layer adjacent the core layer;
an inner fiber-reinforced polymer layer adjacent the core layer; and
at least one wireless sensor positioned within the foam core and coupled to an inner surface of the core fiber-reinforced polymer layer.

2. The composite structure of claim 1, wherein the cargo body includes one of a trailer, a van, a train, and a boat.

3. The composite structure of claim 1, wherein the foam core is coupled to the inner surface of the core fiber-reinforced polymer layer via an intermediate layer positioned between the core fiber-reinforced polymer layer and the foam core.

4. The composite structure of claim 3, wherein the intermediate layer is a permeable material to facilitate contact between the wireless sensor and the core fiber-reinforced polymer layer.

5. The composite structure of claim 1, further comprising a gel coat positioned on at least one of the outer fiber-reinforced polymer layer and the inner fiber-reinforced polymer layer opposite the core layer.

6. The composite structure of claim 1, wherein a control system of the cargo body is communicatively coupled to the wireless sensor, the control system configured to receive and process signals transmitted by the wireless sensor.

7. The composite structure of claim 1, wherein the composite structure is a single, unitary structure.

8. A preform for construction of a composite structure, the preform comprising:
a foam core;
a permeable intermediate layer surrounding the foam core;
a fiber-reinforced polymer layer surrounding the permeable intermediate layer; and
a wireless sensor positioned within the foam core and attached to an inner surface of the permeable intermediate layer so that the at least one wireless sensor contacts the fiber-reinforced polymer layer via pores of the intermediate layer.

9. The preform of claim 8, wherein the fiber-reinforced polymer layer includes a polymer matrix reinforced with a fiberglass fabric.

10. The preform of claim 8, wherein the permeable intermediate layer is a nonwoven fabric.

11. The preform of claim 8, wherein the preform comprises a plurality of wireless sensors.

12. The preform of claim 8, wherein the permeable intermediate layer is mechanically coupled to the fiber-reinforced polymer layer.

13. The preform of claim 8, wherein the foam core comprises a polyurethane foam.

14. The preform of claim 8, wherein the wireless sensor is attached to the inner surface of the permeable intermediate layer via adhesive.

15. A method of manufacturing a composite structure, the method comprising:
providing a fiber-reinforced polymer and a nonwoven fabric;
attaching a wireless sensor to the nonwoven fabric;
providing foam material to the nonwoven fabric and over the wireless sensor relative to the nonwoven fabric;
curing the foam material; and
cutting the composite structure to a predetermined size.

16. The method of claim 15, wherein the foam material is a self-curing material.

17. The method of claim 15, wherein attaching the wireless sensor to the nonwoven fabric comprises applying adhesive to at least one of the wireless sensor and the nonwoven fabric.

18. The method of claim 15, further comprising applying an additional layer of fiber-reinforced polymer to the fiber-reinforced polymer.

19. The method of claim 18, further comprising applying a gel coat to the additional layer of fiber-reinforced polymer.

20. The method of claim 15, wherein a plurality of wireless sensors is attached to the nonwoven fabric.
